(19) United States
(12) Patent Application Publication
(10) Pub. No.: US 2017/0025670 A1
(43) Pub. Date: Jan. 26, 2017

(54) BATTERY CHARGER PROTECTING SYSTEM AND ACTIVE FUSE-PROTECTED DEVICES THEREOF

(71) Applicant: AMITA TECHNOLOGIES INC LTD., Taoyuan City (TW)

(72) Inventors: Jing-Yih CHERNG, Taoyuan City (TW); Hou-Chi CHEN, Taoyuan City (TW); Yi-Cheng CHEN, Taoyuan City (TW)

(21) Appl. No.: 15/169,283

(22) Filed: May 31, 2016

(30) Foreign Application Priority Data
Jul. 20, 2015 (TW) 104123381

(51) Int. Cl. H01M 2/34; H01M 10/42; H01M 10/46; H02J 7/00

(52) U.S. Cl. CPC H01M 2/348; H02J 7/0031; H01M 10/4257; H01M 10/46; H01M 2200/103

(57) ABSTRACT

A battery charger protecting system includes a main circuit board installed with a power supply control unit, an active fuse-protected device, and at least one battery. The active fuse-protected device includes a base, a first electrode fixed in the base, a second electrode connected with an elastic unit, a low melting temperature structure connected between the first electrode and the second electrode, a heater thermally connected with the low melting temperature structure and a fuse control unit electrically connected with the heater and the power supply control unit. The battery is electrically connected with the first electrode and the power supply control unit. The power supply control unit can actively drive the control unit fuse to immediately melt the low melting temperature structure for protecting batteries when an overcurrent occurs.

### BACKGROUND OF THE INVENTION

Field of the Invention

The present invention generally relates to a lithium battery charger protecting system and, in particular to a battery charger protecting system with active fuse-protected devices and active fuse-protected devices thereof.

Description of Prior Art

In a general circuit system, a blown fuse is often used as a means for preventing an overcurrent. However, a blown fuse in an overcurrent condition needs to be held for a certain time to get to a temperature of heat generating. Therefore, the reaction time of a lithium battery charger system is insufficient so that lithium batteries may have been damaged when the fuse blows.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a battery charger protecting system with active fuse-protected devices and active fuse-protected devices thereof.

In order to achieve the object mentioned above, the present invention provides an active fuse-protected device including a base, a first electrode, a second electrode, a low melting temperature structure, a heater and a fuse control unit. The first electrode is fixed in the base. The second electrode is connected with an elastic unit. The low melting temperature structure is connected between the first electrode and the second electrode. The heater is thermal connected with the low melting temperature structure, and the fuse control unit is electrically connected with the heater.

Preferably, the heater can be disposed in the base. The fuse control unit can be disposed in the base. The active fuse-protected device can further include an electrical connector, and the electrical connector is electrically connected with the fuse control unit. The electrical connector can be disposed in the base.

Preferably, the active fuse-protected device can further include a second circuit board, and the fuse control unit is disposed in the second circuit board. The heater can be provided in the base. The heater can be provided in the second circuit board. The electrical connector can also be disposed in the second circuit board and electrically connected with the fuse control unit.

Preferably, the elastic unit can be connected between the base and the second electrode. The elastic unit can also be connected between the first electrode and the second electrode.

In order to achieve the object mentioned above, the present invention provides a battery charger protecting system including a main circuit board, an active fuse-protected device and at least one battery. The main circuit board is disposed with a power supply control unit. The active fuse-protected device including a base, a first electrode fixed in the base, a second electrode connected with an elastic unit, a low melting temperature structure connected between the first electrode and the second electrode, a heater thermal connected with the low melting temperature structure and a fuse control unit electrically connected with the heater and the power supply control unit. The battery is electrically connected with the first electrode and the power supply control unit.

Preferably, the heater can be disposed in the base. The fuse control unit can be disposed in the base. The active fuse-protected device can further include an electrical connector, and the electrical connector is electrically connected with the fuse control unit. The electrical connector can be disposed in the base.

Preferably, the active fuse-protected device can further include a second circuit board, and the fuse control unit is disposed in the second circuit board. The heater can be disposed in the base. The heater can be disposed in the second circuit board. The electrical connector can also be disposed in the second circuit board and electrically connected with the fuse control unit.

The power supply control unit can actively drive the control unit fuse and immediately melt the low melting temperature structure for protecting batteries when an overcurrent occurs.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a battery charger protecting system diagram of a first embodiment of the present invention.

FIG. 2 is a perspective schematic view of an active fuse-protected device of a first embodiment of the present invention.

FIG. 3 is a battery charger protecting system diagram of a second embodiment of the present invention.

FIG. 4 is a perspective schematic view of an active fuse-protected device of a second embodiment of the present invention.

FIG. 5 is a battery charger protecting system diagram of a third embodiment of the present invention.

FIG. 6 is a perspective schematic view of an active fuse-protected device of a third embodiment of the present invention.

FIG. 7 is an operating schematic view of an active fuse-protected device of a third embodiment of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

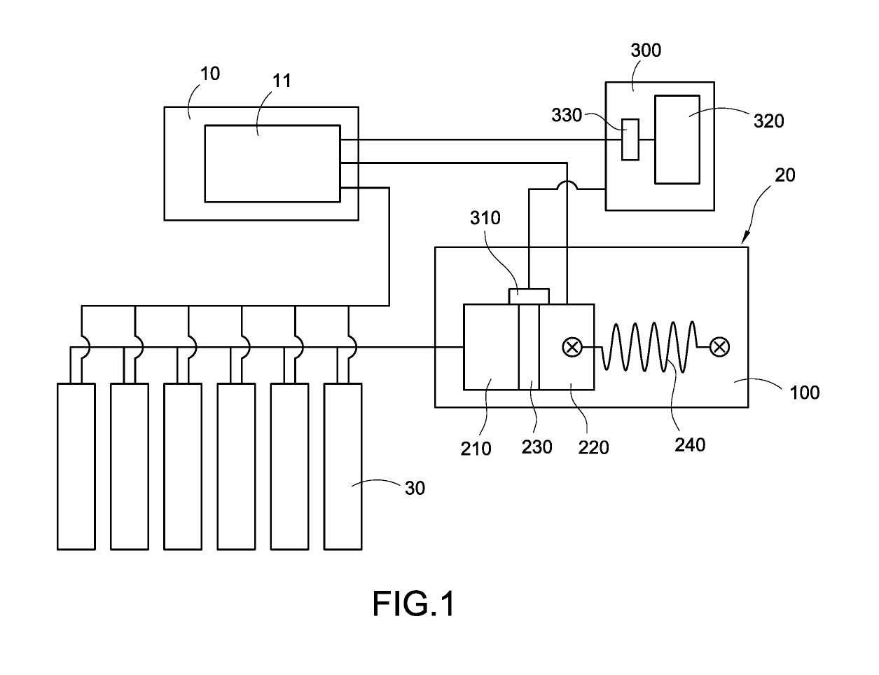

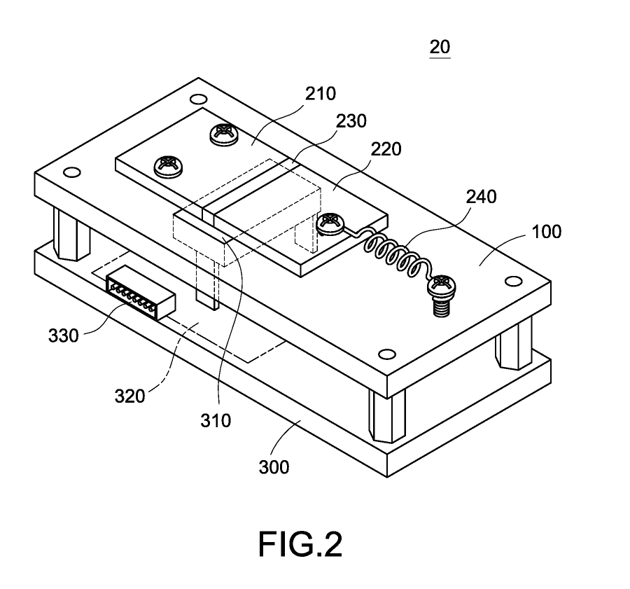

Please refer to FIG. 1 and FIG. 2, a first embodiment of the present invention provides a battery charger protecting system that is implied in a lithium battery manufacturing process for preventing the lithium battery from overcharging when a discharging process of a lithium battery is repeated. The battery charger protecting system of the present invention includes a main circuit board 10, an active fuse-protected device 20 and at least one battery 30.

The main circuit board 10 is disposed with a power supply control unit 11, and the main circuit board 10 is electrically connected to a power. The power type of the present invention is, not limited to, provided as a DC power supply or an AC power supply.

The active fuse-protected device 20 comprises a base 100, a second circuit board 300, a first electrode 210, a second electrode 220, a low melting temperature structure 230, a heater 310, an electrical connector 330 and a fuse control unit 320.

In the present embodiment, the base 10 is, but not limited to, an insulation plate. The second circuit board 300 is parallel and spaced with the base 100. The second circuit board 300 is fixed with the base 100, preferably but not limited to, by at least one column.

The first electrode 210 is, preferably but not limited to, a metal plate such as copper or aluminum. The first electrode 210 is fixed in a side of the base 100. The second electrode 220 is, preferably but not limited to, a metal plate such as copper or aluminum. The second electrode 220 is placed in the base 100 and located at the same side with the first electrode 210, and the second electrode 220 is connected with the base 100 through an elastic unit 240. In the present embodiment, the elastic unit 240 is a spring preferably, and two ends of the elastic unit 240 are fixed in the base 100 and the second electrode 220 separately. The low melting temperature structure 230 is connected between the first electrode 210 and the second electrode 220. In the embodiment, the low melting temperature structure 230 is preferably a solder for soldering the first electrode 210 and the second electrode 220. The first electrode 210 and the second electrode 220 are electrically connected to each other through the low melting temperature structure 230.

The heater 310 can be made of, but not limited to, a metal plate, a metal bar or a metal block. In the present embodiment, the heater 310 is preferably disposed in the second circuit board 300 and extended from the second circuit board 300 to contact the low melting temperature structure 230 for thermal connecting with the low melting temperature structure 230. However, the heater 310 can also be disposed in the base 100 and contact with the low melting temperature structure 230 for thermal connecting, and the heater 310 can electrical connect the second circuit board 300 by wires. The electrical connector 330 is provided in the second circuit board 300 and electrically connected with the fuse control unit 320. The fuse control unit 320 is disposed in the second circuit board 300. The fuse control unit 320 is electrically connected with the heater 310 and the electrical connector 330, and the fuse control unit 320 can be electrically connected with the power supply control unit 11 through the electrical connector 330.

In an embodiment of the present invention, the battery charger protecting system preferably includes a plurality of batteries 30. The electrodes of the batteries 30 are arranged in a parallel way for electrically connected with the first electrode 210 and the power supply control unit 11. The electrodes of the batteries 30 are interchangeable when connect to the first electrode 210 and the power supply control unit 11.

The power supply control unit 11 can be able to control a supply voltage and a supply current of the battery 30. When the battery 30 is charged completely, the power supply control unit 11 can cut off the power supply to prevent an overcharging of the battery 30 from damage. The active fuse-protected device 20 is connected between the battery 30 and the power supply control unit 11. An electrode of each battery 30 is electrically connected with the power supply control unit 11 through the active fuse-protected device 20. The power supply control unit 11 can drive the fuse control unit 320 for supplying power to heater 310 to melt the low melting temperature structure 230 when a charging current or a charging voltage higher than a loading limit is detected. When the low melting temperature structure 230 is melt, the first electrode 210 and the second electrode 220 will be disconnected, and the second electrode 220 is pulled away from the first electrode 210 by the elastic element 240 to ensure that the first electrode 210 and second electrode 220 are separated. Thereby the electrical connection between the battery 30 and the power supply control unit 11 will be disconnected for protecting the battery 30.

Therefore, the power supply control unit 11 of the battery charger protecting system of the present invention can actively drive the fuse control unit 320 to melt the low melting temperature structure 230 when an overcurrent is occurred. With comparing to a conventional blown fuse, a fuse of the present invention has a faster fusing reaction.

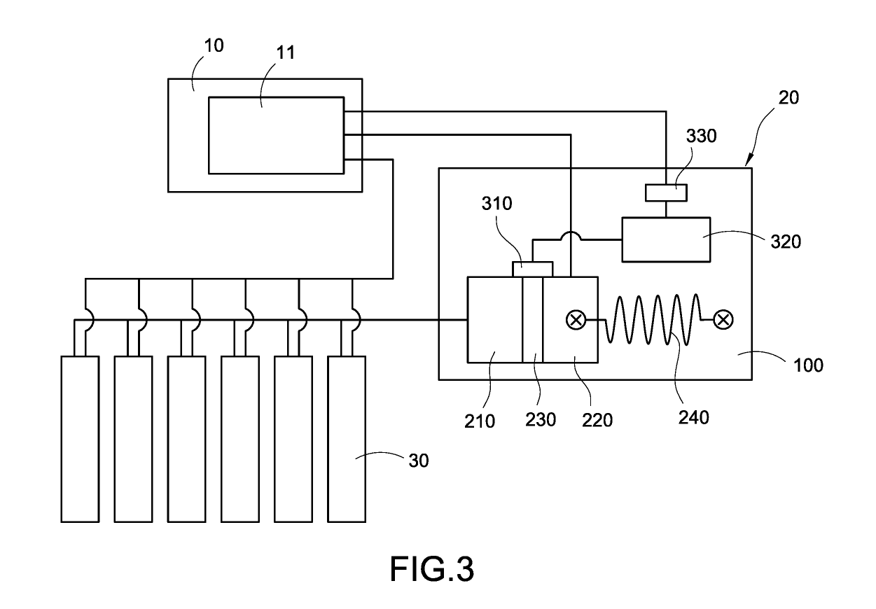

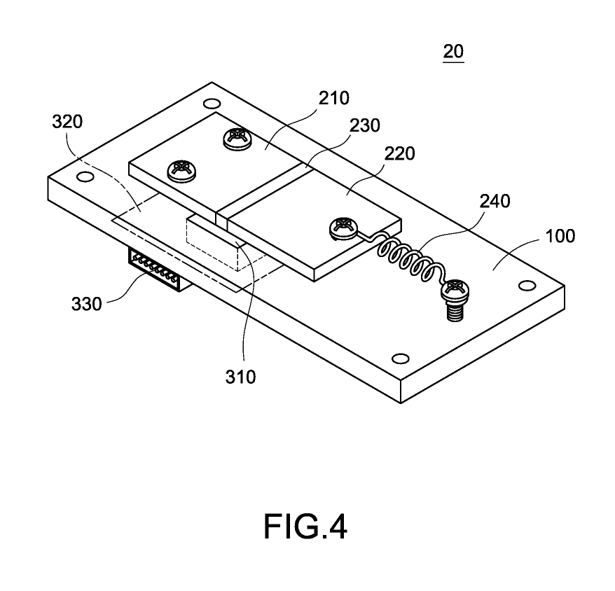

With referring to FIG. 3 and FIG. 4, a second embodiment of the present invention provides a battery charger protecting system comprising a main circuit board 10, an active fuse-protected device 20 and at least one battery 30. The structures of the second embodiment of the present invention are substantially the same as the first embodiment, and that will not be described again here. The second embodiment differs from the first embodiment in that the base 100 of the active fuse-protected device 20 can be a circuit board. The heater 310 and the electrical connector 330 are both disposed in the base 100, and the fuse control unit 320 is also disposed in the base 100. Hence the volume of the active fuse-protected device 20 can be reduced.

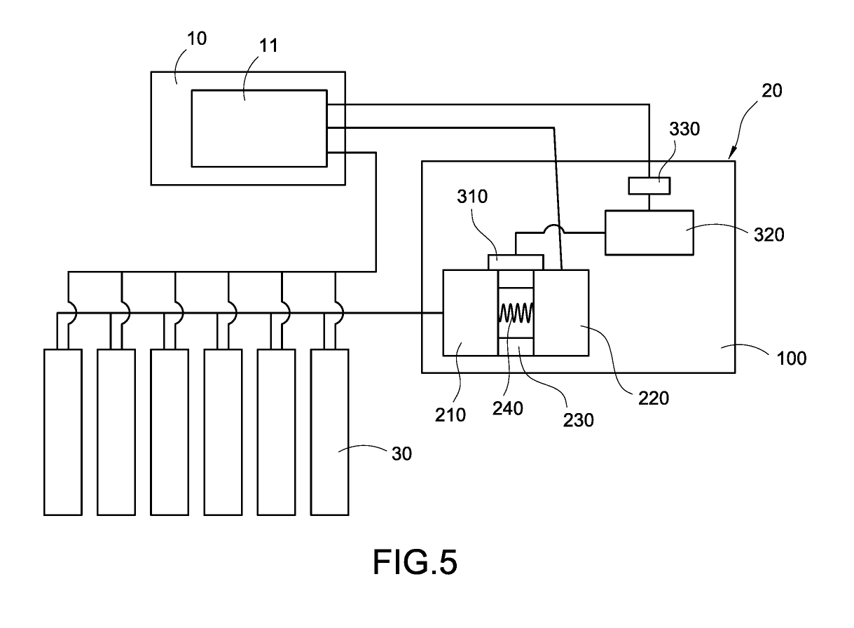

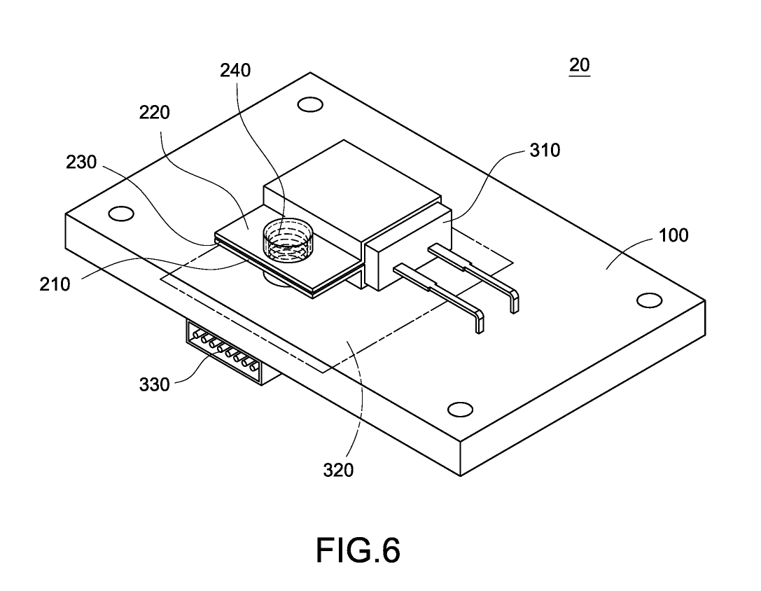

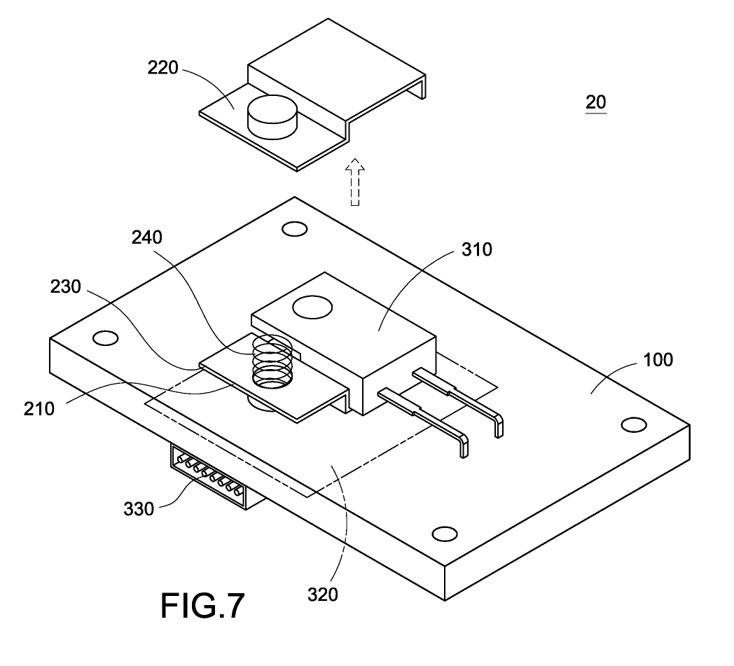

Please refer to FIG. 5 to FIG. 7, a third embodiment of the present invention provides a battery charger protecting system that is implied in a lithium battery manufacturing process for preventing the lithium battery from overcharging when a discharging process of a lithium battery is repeated. The battery charger protecting system of the present invention includes a main circuit board 10, an active fuse-protected device 20 and at least one battery 30.

The main circuit board 10 is disposed with a power supply control unit 11, and the main circuit board 10 is electrically connected to a power. The power type of the present invention is, not limited to, provided as a DC power supply or an AC power supply.

The active fuse-protected device 20 comprises a base 100, a first electrode 210, a second electrode 220, a low melting temperature structure 230, a heater 310, an electrical connector 330 and a fuse control unit 320. In the embodiment, the base 100 is provided as a circuit board.

The first electrode 210 is, preferably but not limited to, a metal plate such as copper or aluminum. The first electrode 210 is fixed in a side of the base 100. The second electrode 220 is, preferably but not limited to, a metal plate, such as copper or aluminum. The second electrode 220 and the first electrode 210 are stacked in the same side of the base 100. An elastic unit 240 is sandwiched between the first electrode 210 and the second electrode 220. In the present embodiment, the elastic unit 240 is preferably a spring, and two ends of the elastic unit 240 abut against the first electrode 210 and the second electrode 220 separately. The elastic unit 240 is compressed and held between the first electrode 210 and the second electrode 220. The low melting temperature structure 230 is connected between the first electrode 210 and the second electrode 220. In the embodiment, the low melting temperature structure 230 is preferably a solder for soldering the first electrode 210 and the second electrode 220, and the first electrode 210 and the second electrode 220 are electrically connected to each other through the low melting temperature structure 230.

In the embodiment, the heater 310 and the electrical connector 330 are both disposed in the base 100, and the fuse control unit 320 is also disposed in the base 100. The heater 310 and the electrical connector 330 are electrical connected with the fuse control unit 320 separately.

A part of the heater 310 is held between the first electrode 210 and the second electrode 220. The heater 310 can thermal connect with the low melting temperature structure 230 through the first electrode 210 and the second electrode 220, and the fuse control unit 320 can electrically connect with the power supply control unit 11 through the electrical connector 330.

In the present embodiment, the battery charger protecting system preferably includes a plurality of batteries 30. Two electrodes of the batteries 30 are arranged in a parallel way for electrically connected with the first electrode 210 and the power supply control unit 11. The electrodes of the batteries 30 for connecting with the first electrode 210 and the power supply control unit 11 are interchangeable.

The power supply control unit 11 can be able to control a supply voltage and a supply current of the battery 30. When the battery 30 is charged completely, the power supply control unit 11 can cut off the power supply to prevent an overcharging of the battery 30 from damages. The active fuse-protected device 20 is connected between the battery 30 and the power supply control unit 11. An electrode of each battery 30 is electrically connected with the power supply control unit 11 through the active fuse-protected device 20. The power supply control unit 11 can drive the fuse control unit 320 for supplying power to heater 310 to melt the low melting temperature structure 230 when a charging current or a charging voltage higher than a loading limit is detected. When the low melting temperature structure 230 is melt, the first electrode 210 and the second electrode 220 will be disconnected, and the second electrode 220 is pulled away from the first electrode 210 by the elastic element 240 to ensure that the first electrode 210 and second electrode 220 are separated. Thereby the electrical connection between the battery 30 and the power supply control unit 11 will be disconnected for protecting the battery 30.

Although the present invention has been described with reference to the preferred embodiment thereof, it will be understood that the invention is not limited to the details thereof.

Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. An active fuse-protected device, comprising:
a base;
a first electrode fixed in the base;
a second electrode connected with an elastic unit;
a low melting temperature structure connected between the first electrode and the second electrode;
a heater thermal connected with the low melting temperature structure; and
a fuse control unit electrically connected with the heater.

2. The device according to claim 1, wherein the heater is provided in the base.

3. The device according to claim 1, wherein the fuse control unit is disposed in the base.

4. The device according to claim 1, further comprising an electrical connector, wherein the electrical connector is electrically connected with the fuse control unit.

5. The device according to claim 1, wherein the electrical connector is disposed in the base.

6. The device according to claim 1, further comprising a second circuit board, wherein the fuse control unit is disposed in the second circuit board.

7. The device according to claim 6, wherein the heater is disposed in the base.

8. The device according to claim 6, wherein the heater is disposed in the second circuit board.

9. The device according to claim 6, further comprising an electrical connector, wherein the electrical connector is disposed in the second circuit board and electrically connected with the fuse control unit.

10. The device according to claim 1, wherein the elastic unit is connected between the base and the second electrode.

11. The device according to claim 1, wherein the elastic unit is connected between the first electrode and the second electrode.

12. A battery charger protecting system, comprising:
a main circuit board disposed with a power supply control unit;
an active fuse-protected device including a base, a first electrode fixed in the base, a second electrode connected with an elastic unit, a low melting temperature structure connected between the first electrode and the second electrode, a heater thermal connected with the low melting temperature structure and a fuse control unit electrically connected with the heater and the power supply control unit; and
at least one battery electrically connected with the first electrode and the power supply control unit.

13. The system according to claim 10, wherein the heater is disposed in the base.

14. The system according to claim 10, wherein the fuse control unit is disposed in the base.

15. The system according to claim 10, wherein the active fuse-protected device includes an electrical connector; and the electrical connector is electrically connected with the fuse control unit.

16. The system according to claim 10, wherein the electrical connector is disposed in the base.

17. The system according to claim 10, wherein the active fuse-protected device includes a second circuit board; and the fuse control unit is disposed in the second circuit board.

18. The system according to claim 15, wherein the heater is disposed in the base.

19. The system according to claim 15, wherein the heater is disposed in the second circuit board.

20. The system according to claim 15, wherein the active fuse-protected device includes an electrical connector, the electrical connector is disposed in the second circuit board and electrically connected with the fuse control unit.
